(19) United States
(12) Patent Application Publication
(10) Pub. No.: US 2012/0216780 A1
(43) Pub. Date: Aug. 30, 2012

(54) Backwards Injected Engine

(76) Inventor: Francis Xavier Gentile, Los Angeles, CA (US)

(21) Appl. No.: 13/355,572

(22) Filed: Jan. 23, 2012

Related U.S. Application Data
(63) Continuation of application No. 12/758,873, filed on Apr. 13, 2010, now Pat. No. 8,104,450.

(51) Int. Cl. F02M 61/14

(52) U.S. Cl. 123/470

(57) ABSTRACT

Fuel is injected into and through the exhaust port and into the cylinder of the piston engine during the time when the flow is reversed from the normally expected flow. The engine is able to operate with some or all of its fuel injected backwards of conventional expectations. In another embodiment the fuel is injected with solid stream injector sprays directed against exhaust valves and ports and deflected into the piston cylinder against the flow of normally aspirated or supercharged engines. This invention can apply to gasoline or diesel cycles and four and two stroke type cycles of engine.

### CROSS REFERENCE TO RELATED APPLICATIONS

This application is a Continuation of Ser. No. 12/758,873 filed 2010 Apr. 13 by the present Inventor, which is incorporated by reference. This application claims the benefit of PPA Ser. No. 61/168,625 filed 2009 Apr. 13 by the present Inventor, which is incorporated by reference. Application PCT Ser. Nr. PCT/US10/30957 filed 2010 Apr. 14, continuing in part Ser. Nr. PCT/US10/52422 filed 2010 Oct. 13 and continuing in Part U.S. Ser. No. 12/903,286 filed 2010 Oct. 13 by the present Inventor, are related to this application.

### BRIEF DESCRIPTION OF THE SEVERAL VIEWS OF THE DRAWINGS

### Drawings

### Figures

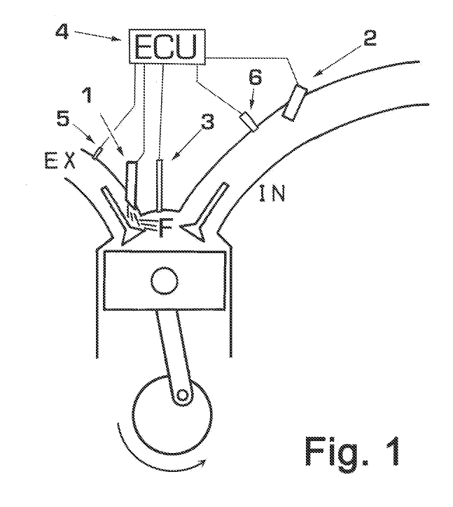

FIG. 1 Shows a System Schematic.

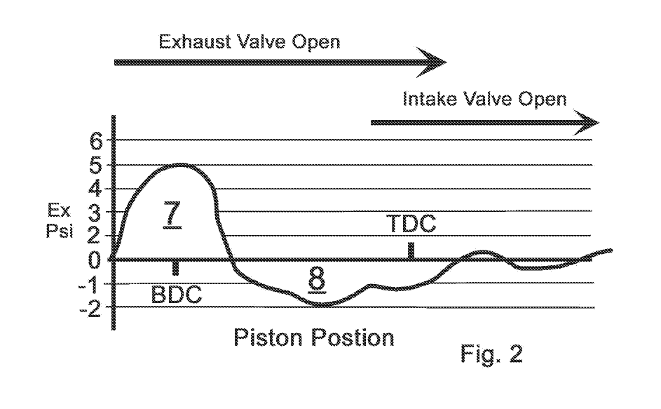

FIG. 2 Shows an example exhaust tract pressure map for a four stroke poppet valve engine is shown as an example in graph FIG. 2.

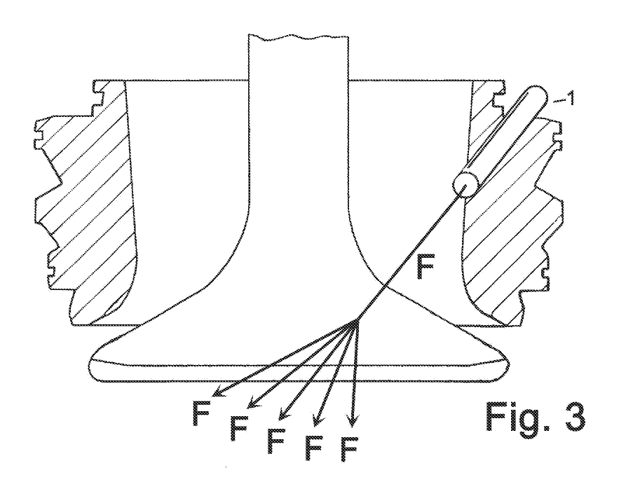

FIG. 3 Shows an embodiment of deflecting solid streams of fuel (F) (or water) onto the exhaust valves.

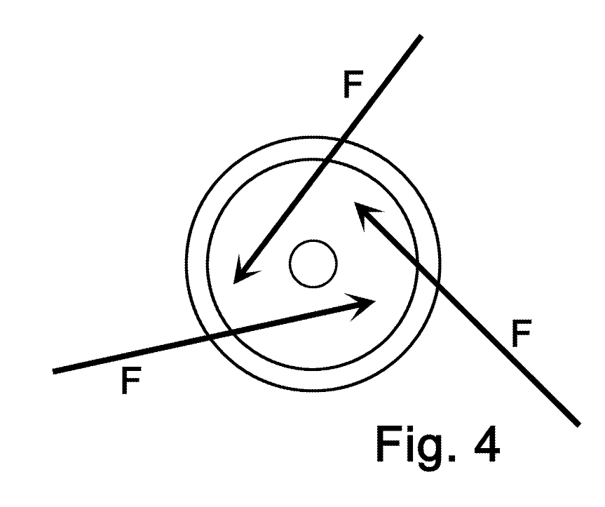

FIG. 4 Shows a view of an exhaust poppet valve from above showing an embodiment with three solid stream fuel (F) injection streams deflected off of evenly distributed points of the valve.

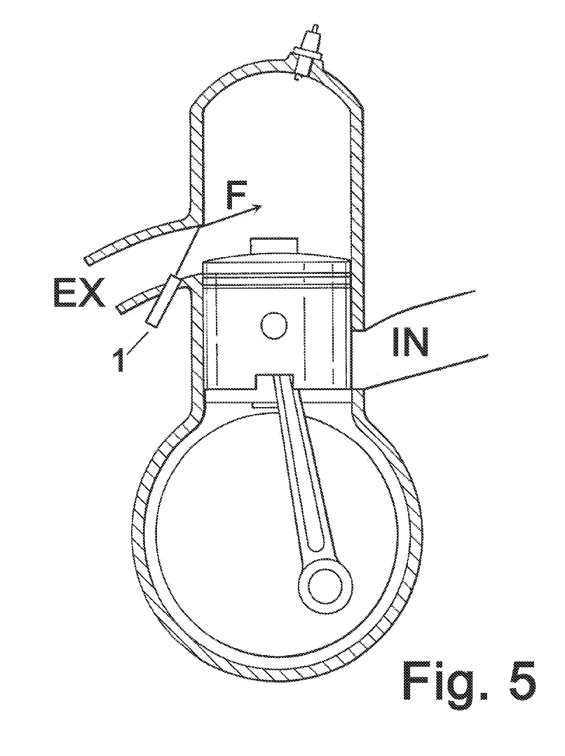

FIG. 5 illustrates an embodiment of one or more solid stream or non-atomizing fuel injector's 1 injections are deflected against the exhaust tract edge of a piston operated cylinder exhaust valve port and said stream (F) is deflected into said combustion chamber and or cylinder of a two stroke engine.

In one embodiment a piston in an internal combustion engine is pushed down to the bottom of the cylinder which causes the opening of exhaust ports. The pressure in the exhaust piping is positive 7 (FIG. 2) after combustion. The pressure is released in a wave out the exhaust system. After the positive pressure wave comes a negative pressure wave 8 (FIG. 2) which is the indication of flow known to be capable of bringing exhaust gases back thru the combustion chamber and as far as the intake tract (IN) (FIG. 1). An example exhaust tract pressure map for a four stroke poppet valve engine is shown as an example in graph FIG. 2. In practice the shape of the graph may be difficult to predict and depends on the engine configuration and operating conditions. The waves of energy are sometimes described as caused by the subsonic organ pipe effect of the end of the pipe causing the reflection backwards to its origin based on the length of the pipe. The reflections have also been described by the supersonic shock waves which can emanate from the pressure release of the opening of the exhaust valve and also reflect backwards from the end of the exhaust tube towards the origin at the exhaust valve.

Pressure in the Exhaust tract is an indirect indication of the direction of flow with in the exhaust tract, positive is flow outward from the cylinder and negative pressure into the cylinder which can be cross verified by intake pressure, crankshaft or camshaft position, cylinder pressure. In one embodiment pressure sensors in the exhaust tract 5 (FIG. 1), combustion chamber 3 (FIG. 1), intake tract 6 (FIG. 1) send condition information to the Engine Control Unit (ECU) 4 (FIG. 1). The ECU triggers fuel injectors in the exhaust port 1 (FIG. 1). The ECU can also trigger fuel injector 2 (FIG. 1) on the conventional intake side when conditions are desirable or necessary such as when the engine is cold and starting. For simplicity the other sensors commonly used on fuel injections are not shown in the diagram, but would or could be used, for example, oxygen sensor, knock sensor, air mass sensor, intake temperature, cylinder head temperature, exhaust gas temperature.

Another embodiment of this invention utilizes variations in the fuel delivered from the intake and the exhaust ports to achieve variation in fuel to air ratios that allow ignition while also allowing complete burning without high combustion temperatures which lead to nitrogen oxide formation.

Another embodiment of this invention utilizes different fuels in the intake versus the exhaust to better achieve the results described in the paragraph above.

In FIG. 3 show An embodiment of deflecting solid streams of fuel (F) (or water) onto the exhaust valves to create atomization of fuel, entry of fuel into the combustion chamber against or with the gas flow, cooling of the valve central body.

As velocity decreases over distance more rapidly as droplets form and become smaller, a solid stream therefore maintains the maximum velocity against turbulence and opposite gas flow and therefore is able to oppose and traverse the exhaust gas flow. The impact of the solid stream on the poppet valve produces different liquid sheet angles and the break-up lengths at various angles and locations of impact on different shapes of valves.

Restated, Solid stream nozzles provide the highest impact per unit area. The large free passage design through the typically round solid stream nozzle orifice reduces clogging. In one embodiment a solid stream non-atomized spray directed against the exhaust valve achieves fuel heating and atomization from the deflection impact against the valve and the fuel charge flow against the flow of exhaust gases.

More than one injector can be used to create even thermal conditions in the valve metal which would reduce internal stresses within the metal because of differences in thermal expansion and contraction. FIG. 4 is a view of an exhaust poppet valve from above showing an embodiment with three solid stream fuel (F) injection streams deflected off of evenly distributed points of the valve.

The location of the highest heat in the valve is presented in U.S. Pat. No. 4,073,474. Heat in the poppet valve periphery that contacts the valve seat is conducted away from the poppet valve. The hot center of the valve disk or head expands the metal against the cooler less thermally expended valve head periphery in contact with the valve seat, resulting in hoop stress and cracks within the valve periphery that contacts the valve seat within the intake tract. In one embodiment of this invention cooling from fuel and or water spray would be best directed upon this hot center of the valve head. Described in alternate language, the solid spray impacts between the beginning of the poppet valve stem and the beginning of the part of the valve periphery which makes contact with the valve seat in the cylinder head.

Fortunately the exhaust valve is typically placed in the cylinder head with a short exit path to the exhaust header, so it maybe possible to perform conversions of existing engines by installing injectors in the exhaust headers. Smaller injectors know as pico injectors are available. Smaller single cylinder engines or engines with separated cylinders allow more direct access to the exhaust valve from many directions and thus are better candidates for inexpensive conversion.

Small two stroke engines present a simpler conversion. FIG. 5 illustrates embodiment of one or more solid stream or non-atomizing fuel injector's 1 injections are deflected against the exhaust tract edge of a piston operated cylinder exhaust valve port and said stream (F) is deflected into said combustion chamber and or cylinder of a two stroke engine.

### Copy of Paragraph 3 of the Provisional Patent:

This conception of injecting fuel into the combustion chamber from the exhaust side of the engine is unexpected because conventional expectations do not see flow going this direction. Conventional expectations are also that the injection into this area would cause a back fire or wasted fuel. In some cases fuel is injected into the exhaust port, but it is designed to combust there and flow out the exhaust pipe to provide heating and preparation of the mixture for the catalytic converter. In this invention the fuel is designed to go into the combustion chamber and be burned there for propulsion.

### Copy of Paragraph 4 of the Provisional Patent:

The hot surfaces of the exhaust tract and ports and exhaust valves that would normally be considered a structural melting problem are used to heat and make gaseous (volatilize) the liquid fuel which results in better combustion. The fuel spray also serves to cool the problematically hot exhaust valve. Heavier fuels can used because of the hot volatilization. The cooling of the exhaust ports and valves reduces the potential for uncontrolled burning or detonation caused by the hot surfaces and thus suppresses the very reason that this invention would be considered impossible to implement.

### Copy of Paragraph 8 of the Provisional Patent:

Another embodiment of this invention utilizes variations in the fuel delivered from the intake and the exhaust ports to achieve variation in fuel to air ratios that allow ignition while also allowing complete burning without high combustion temperatures which lead to nitrogen oxide formation.

### Copy of Paragraph 9 of the Provisional Patent:

Another embodiment of this invention utilizes different fuels in the intake versus the exhaust to better achieve the results described in the paragraph above.

### Paragraph 10 of the Provisional Patent:

Another embodiment of this invention utilizes water or its vapors or constituent parts of water in the exhaust port injector to cool the cylinder charge and the components of the cylinder itself to achieve the results described in the above.

What is claimed is:

1. A supercharged or naturally aspirated internal combustion piston engine with separate intake and exhaust poppet valves with substantially and continuously separate exhaust and intake tracts leading separately to the atmosphere, whose exhaust tract is of a length and continuity where no substantial fresh air would flow backwards down said exhaust tract into the combustion chamber as a result of common pressure waves, wherein the fuel is forcibly injected from within said exhaust tract into said combustion chamber thru said open exhaust valve port into said combustion chamber and cylinder by one or more solid stream or non-atomizing fuel injector's injections being deflected against the area of the exhaust poppet valve that exists between the stem of said valve and the part of said valve which touches said valve seat when closed, and said stream is deflected into said combustion chamber and or cylinder for the next cycle of combustion thru said exhaust valve of said combustion chamber or said cylinder from a distance from said exhaust valve equal to less than 7 diameters of the circle equivalent two dimensional sectional area of said exhaust valve tract and face opening junction, timed so that said fuel will arrive and pass through the exhaust valve while said exhaust valve is open.

2. The engine of claim 1 wherein the fuel is injected from a distance from said exhaust valve equal to less than 5 diameters of the circle equivalent two dimensional sectional area of said exhaust valve tract and face opening junction.

3. The engine of claim 1 wherein the fuel is injected from a distance from said exhaust valve equal to less than 2 diameters of the circle equivalent two dimensional sectional area of said exhaust valve tract and face opening junction.

4. The engine of claim 1 wherein the fuel is injected from a distance from said exhaust valve equal to less than 1 diameter of the circle equivalent two dimensional sectional area of said exhaust valve tract and face opening junction.

5. The invention engine as in claim 1, 2, 3, or 4 comprising a single injector creating 2 solid injection streams that are deflected against the area of said exhaust poppet valve that exists between the stem of said exhaust valve and the part of said exhaust valve which touches said exhaust valve seat when closed, whose fuel injections are evenly spaced around the circular shape and at a fuel angle to the impacted surface of said exhaust valve that is between perpendicular and tangent and the streams are deflected into said combustion chamber and or said cylinder.

6. The invention engine as in claim 1, 2, 3, or 4 comprising a single injector creating 3 solid injection streams that are deflected against the area of said exhaust poppet valve that exists between the stem of said exhaust valve and the part of said exhaust valve which touches said exhaust valve seat when closed, whose fuel injections are evenly spaced around the circular shape and at a fuel angle to the impacted surface of said exhaust valve that is between perpendicular and tangent and the streams are deflected into said combustion chamber and or said cylinder.

7. The invention engine as in claim 1, 2, 3, or 4 comprising a single injector creating 4 solid injection streams that are deflected against the area of said exhaust poppet valve that exists between the stem of said exhaust valve and the part of said exhaust valve which touches said exhaust valve seat when closed, whose fuel injections are evenly spaced around the circular shape and at a fuel angle to the impacted surface of said exhaust valve that is between perpendicular and tangent and the streams are deflected into said combustion chamber and or said cylinder.

8. The invention engine as in claim 1, 2, 3, or 4 comprising a single injector creating 5 solid injection streams that are deflected against the area of said exhaust poppet valve that exists between the stem of said exhaust valve and the part of said exhaust valve which touches said exhaust valve seat when closed, whose fuel injections are evenly spaced around the circular shape and at a fuel angle to the impacted surface of said exhaust valve that is between perpendicular and tangent and the streams are deflected into said combustion chamber and or said cylinder.

9. The invention engine as in claim 1, 2, 3, or 4 comprising a single injector creating 6 solid injection streams that are deflected against the area of said exhaust poppet valve that exists between the stem of said exhaust valve and the part of said exhaust valve which touches said exhaust valve seat when closed, whose fuel injections are evenly spaced around the circular shape and at a fuel angle to the impacted surface of said exhaust valve that is between perpendicular and tangent and the streams are deflected into said combustion chamber and or said cylinder.

10. The invention engine as in claim 1, 2, 3, or 4 where one or more of the injectors inject water.

11. A kit for adding exhaust valve water or fuel injection to existing poppet valve piston engines comprising:
a. one or more drill bits and countersinks
b. one or more drill guide bushings to round pipe fixtures
c. angled or straight threaded ferrules with a ball end allowing some adjustment of angle of the injector
d. ferrule clamping nut with rounded socket washer interface curved to pipe exterior circumference.
e. sealant and gaskets
f. injectors to which fits into and thru the ferrule nut and is compression clamped by the tightening of the ferrule clamping nut.
g. cabling between the injectors and the ECU
h. ECU, engine control unit
i. pipe and hose
j. one or more pipe manifolds
k. electrical or mechanical fuel pump
l. Y tube fitting to access existing fuel or water tanks
m. Sensor plates on the camshaft
o. cabling between the camshaft sensor and ECU
p. a container of antisieze thread lubricant compound
q. a container of electrical contact protectant compound
